(19) United States
(12) Patent Application Publication
(10) Pub. No.: US 2024/0259325 A1
(43) Pub. Date: Aug. 1, 2024

(54) Transmission of Response Message for Time Sensitive Communication

(71) Applicant: Telefonaktiebolaget LM Ericsson (publ), Stockholm (SE)

(72) Inventors: György Miklós, Pilisborosjenö (HU); Balázs Varga, Budapest (HU); János Farkas, Kecskemét (HU)

(21) Appl. No.: 18/561,171

(22) PCT Filed: May 21, 2021
(86) PCT No.: PCT/EP2021/063711

§ 371 Date: Nov. 15, 2023

(51) Int. Cl. H04L 47/28

(52) U.S. Cl. CPC H04L 47/28

(57) ABSTRACT

Embodiments of the present disclosure provide a method, a network node, and a computer program product for transmission of a response message, in a wireless communication system (100). The method is performed by a network nod (50) of an access network (102) in the wireless communication system (100). The method comprises receiving (302) time-sensitive communication assistance information, TSCAI, including TSC configuration parameters from a session management function, SMF. Further, the method comprises transmitting (304) a response message intended for one or more of: at least one network function associated with a core network, CN (104), and an application function, AF, said response message indicating whether or not the network node satisfies the TSC configuration parameters in the TSCAI. Corresponding network node, and computer program products are also disclosed.

### TECHNICAL FIELD

The present disclosure relates generally to the field of wireless communication. More particularly, it relates to method, network node and computer program products for transmission of a response message for time sensitive communication.

### BACKGROUND

Various radio access technologies, RATs, have been developed in recent times and these RATs have been adopted for use in various telecommunication standards to provide a common protocol that enables different wireless devices to communicate with each other.

An example of an emerging telecommunication standard is the fifth generation new radio, 5G NR. The 5G NR is a set of enhancements to the long term evolution, LTE, mobile standard developed by the third generation partnership project, 3GPP. The 5G NR is designed to support mobile broadband Internet access by improving spectral efficiency, reducing costs, and improving services.

In particular, Industrial Internet of Things, IIoT, has been envisioned to become an important 5G application. In order to support delay-sensitive requirements of the IIoT applications, time-sensitive communications, TSC, for 5G is an emerging technology. On the other hand, an Ethernet-based time-Sensitive networking, TSN, solution has been developed for low-latency, low-jitter, and low lost-rate networking applications, such as gaming, delay-sensitive remote control, robotics control, industrial automation, motion control, automated guided vehicles, AGV, control, etc.

As such, there may be scenarios in which a 5G wireless network is used to provide TSN services. Since Ethernet-based TSN mechanisms improve the deterministic delivery of time-sensitive packets, accurate reference timing is needed for Ethernet-based TSN.

The 3GPP system aspects 2, 3GPP SA2, has specified how the 5G wireless network is enabled to be integrated with the TSN. The architecture for integrating a 5G system into the TSN is defined in 3GPP TS 23.501.

FIG. 1A illustrates in more detail how information about a specific TSN stream is provided to a radio access network, RAN, node. Apart from traditional 3GPP quality of service, QoS, information, additional information about the TSN stream is provided in time sensitive communication assistance information, TSCAI.

Application function, AF 60 derives information about the TSN stream from the information provided by a central network controller, CNC 70, in the form of bridge management information, and possibly using other configuration data. The AF 60 determines the QoS parameters including: priority, the Maximum Burst Size, the delay and the Maximum Bitrate, and provides these parameters to a policy control function, PCF 85. Additionally, the AF 60 constructs a TSC Assistance Container, which includes a burst arrival time, BAT, a period and a flow direction i.e., uplink or downlink direction.

The PCF 85 derives 5QI and the associated QoS parameters, and transmits them to a session management function, SMF 80 accordingly. The TSC assistance container is transferred transparently by the PCF 85 to the SMF 80.

The SMF 80 derives the TSCAI from the TSC Assistance Container. In the derivation, the timing information is converted from the TSN external clock to the 5G clock. If the information is aggregated for multiple QoS flows, then the SMF 80 maps it to the individual flows. The SMF 80 also updates the BAT by adding a packet delay budget in the downlink, and the UE-DS-TT residence time in the uplink, to obtain a time interval on when the traffic arrives to RAN 102 or UE 40. In some instances, the survival time is also defined as an additional parameter in the TSCAI.

The SMF 80 provides the TSCAI to the RAN 102 via the AMF 90. The SMF a80lso provides the flow QoS parameters to the RAN 102 via the AMF 90. The RAN 102 takes into account the TSCAI in the resource allocation decisions. However, there is no response from the RAN based on the received TSCAI.

Further, the IIoT has extended the architecture framework to non-TSN scenarios using a network exposure framework. Even IP based applications may request TSC services through a network exposure function, NEF. The architecture for non-TSN scenario is shown in the FIG. 1B.

In this case, AF 60 is regarded as a non-trusted entity, and hence the AF 60 communicates via NEF 65. The NEF 65 has the possibility authorize the request, however the NEF 65 does not know the immediate, detailed resource situation in the RAN 102. Thus, the NEF 65 can only authorize the request based on general policies. The TSC Container is provided by the AF 60 and transferred via the NEF 65 and PCF 85 to the SMF 80. Alternatively, it is also possible that the TSC Container is created by the NEF 65 based on input parameters that are transmitted from the AF 60 to the NEF 65.

### SUMMARY

The RAN may or may not be able to serve the TSC stream, but currently the RAN has no mechanism to respond to the TSCAI information and indicate whether or not it can satisfy the request. Further, the RAN cannot to indicate whether it could serve the stream with different parameters.

Consequently, there is a need for an improved method and arrangement for transmission of a response message for time sensitive communication, TSC, that alleviates at least some of the above cited problems.

It is therefore an object of the present disclosure to provide a method, a network node, and a computer program product for transmission of a response message for TSC that seeks to mitigate, alleviate, or eliminate all or at least some of the above-discussed drawbacks of presently known solutions.

This and other objects are achieved by means of a method, a network node and a computer program product as defined in the appended claims. The term exemplary is in the present context to be understood as serving as an instance, example or illustration.

According to a first aspect of the present disclosure, a method for transmitting a response message for time sensitive communication, TSC, is provided. The method is performed by a network node of an access network in a wireless communication system. The method comprises receiving time-sensitive communication assistance information, TSCAI, including TSC configuration parameters from a session management function, SMF. The method comprises transmitting a response message intended for one or more of: at least one network function associated with a core network, CN, and an application function, AF, said response message indicating whether or not the network node satisfies the TSC configuration parameters in the TSCAI.

In some embodiments, the method further comprising transmitting an indication to one or more of: the at least one network function associated with the CN and the AF for adjusting configuration of one or more TSC configuration parameters.

In some embodiments, the TSC configuration parameters comprises one or more of: a direction of a TSC flow, a periodicity, a burst arrival time, BAT, a survival time, a rank indicating a priority for each of the TSC flow and a delay interval for each TSC flow.

In some embodiments, the response message comprises one or more of: an indication whether at least one of the TSC flows is allowed to be established through the network node, a new BAT for a TSC flow, a delay interval for each BAT corresponding to each TSC flow, the rank associated with the respective TSC flow, a quality of service, QoS, flow identifier, QFI, associated with the TSCAI, a periodicity, a delay interval, and a survival time. In some embodiments, the step of transmitting the response message intended for one or more of: the at least one network function associated with a core network, CN (104) and the AF comprises transmitting the response message in response to the reception of the TSCAI.

In some embodiments, the step of transmitting the response message intended for one or more of: the at least one network function associated with a core network, CN (104) and the AF comprises determining availability of resources at the network node for allowing the TSC flows to be established through the network node. Further, the method comprises transmitting the response message when the resources are available at the network node.

In some embodiments, the response message is transmitted to the AF through one or more network functions of the core network, CN, in the wireless communication system.

In some embodiments, the response message indicates availability of resources at the network node and is transmitted to a network exposure function, NEF of the CN.

According to a second aspect of the present disclosure, a network node for transmitting a response message for a time sensitive communication is provided. The network node being adapted for receiving time-sensitive communication assistance information, TSCAI, including TSC configuration parameters from a session management function, SMF. The network being adapted for transmitting a response message intended for one or more of: at least one network function associated with a core network, CN, and an application function, AF, said response message indicating whether or not the network node satisfies the TSC configuration parameters in the TSCAI.

According to a third aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

An advantage of some embodiments is that a response message is transmitted by the network node for time sensitive communication, TSC, in response to reception of the TSCAI.

An advantage of some embodiments is that the response message from the network node may be used to reject some of the TSC flows in order to maintain quality of service, QoS, requirements of other flows. Further, the response message may also be used to adjust the configuration parameters of the TSC flow for efficient utilization of resources.

An advantage of some embodiments is that, the network node or a radio access network, RAN, may explicitly indicate the rejection of TSC flows by transmitting the response message. Thus, rejection of some of the TSC flows, allows conservation of the radio resources for the other flows such that their QoS requirements can be satisfied.

An advantage of some embodiments is that, the network node may indicate traffic parameters, such as when a burst should arrive, and this indication may be considered at a traffic source. Thus, the network node may be able to more efficiently schedule traffic flows, which eventually leads to more TSN streams that can be accepted by the wireless communication system.

An advantage of some embodiments is that, the network node may decide to perform admission control based on the availability of resources at the network node. Further, some embodiments are also applicable for time sensitive networking, with a central network controller, CNC, as the CNC cannot determine the availability of resources at the RAN.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1A discloses an example fifth generation, 5G, wireless network integrated with a time sensitive network, TSN;

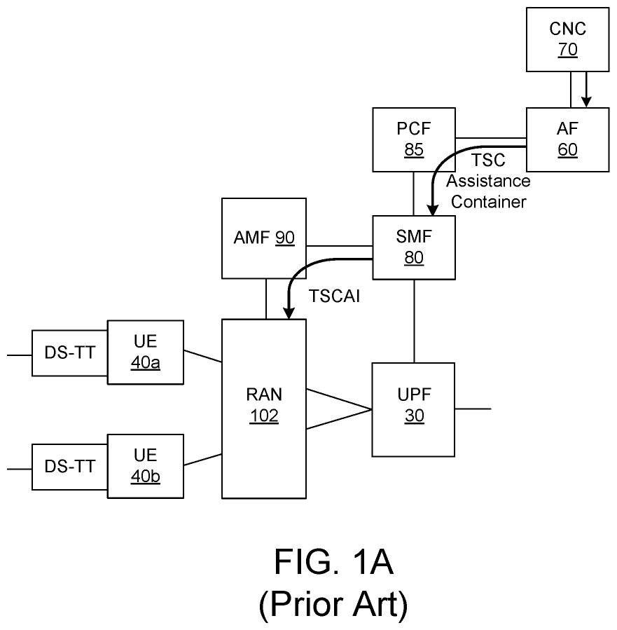

FIG. 1B discloses an example 5G wireless network integrated with a non-TSN network;

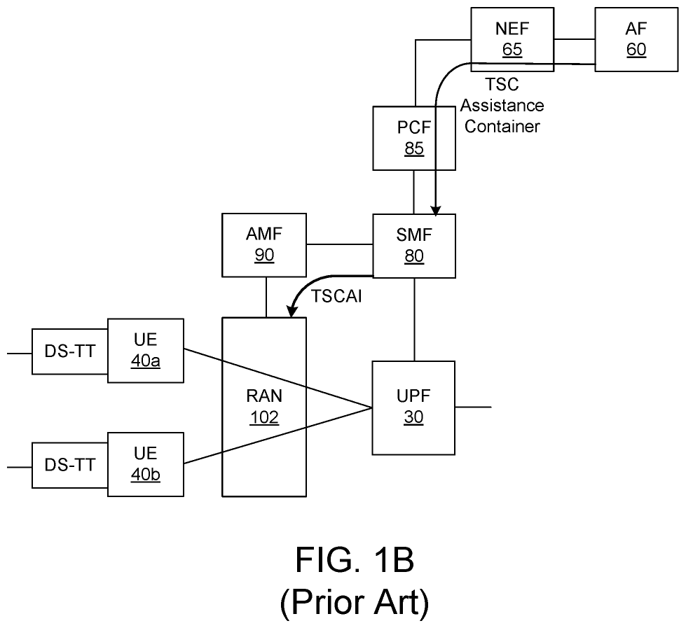

FIG. 2 discloses an example wireless communication system;

FIG. 3 is a flowchart illustrating example method steps of a method for transmission of a response message for time sensitive communication performed by a network node of an access network in a wireless communication system;

FIG. 4 is an example signaling diagram for transmission of a response message to an application function through one or more network functions;

FIG. 5 is an example signaling diagram for transmission of resource availability information to a network exposure function through one or more network functions;

FIG. 6 is an example schematic diagram showing functional modules of the network node;

FIG. 7 discloses an example computing environment.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the present disclosure, user equipments, UEs, also known as mobile terminals, and/or wireless terminals are enabled to communicate wirelessly with a network node in a wireless communication network.

Typically, a network node may serve or cover one or several cells of the wireless communication network. That is, the network node provides radio coverage in the cell(s) and communicates over an air interface with user equipments, UEs, operating on radio frequencies within its range. The network node may be also referred to as “eNB”, “eNodeB”, “NodeB” or “gNB”, depending on the technology and terminology used. In the present disclosure, the network node device may also be referred to as a base station, BS.

In the present disclosure, it is assumed that connection establishment has already been completed between the UE(s) and the network node.

In the following description of exemplary embodiments, the same reference numerals denote the same or similar components.

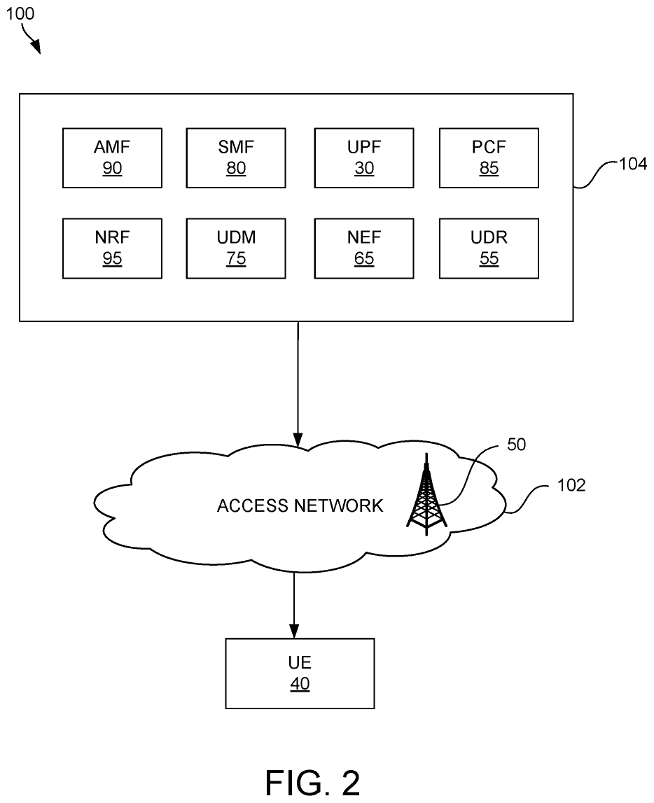

FIG. 2 discloses an example wireless communication system 100 in which the method as disclosed herein can be implemented. As depicted in FIG. 2, the wireless communication system 100 includes an access network 102, a core network, CN 104 and a user equipment, UE 40. The access network 102 includes a network node which can be a base station 50.

The access network 102, which is also referred to as radio access network, RAN, which is directly connected to a user device, for example, a terminal 40, is an infrastructure that provides wireless connection to the terminal 40. The RAN 102 may include a group of a plurality of base stations including a base station 50, and the plurality of base stations may perform communication via an interface. The base station 50 may have a structure having a central unit, CU, and a distributed unit, DU, separated from each other. In this case, one CU may control a plurality of DUs. The base station 50 may be referred to as an access point, AP, a next-generation node i.e., a gNB, a 5th generation node, a wireless point, or a transmission/reception point, TRP, or the like. The terminal 40 accesses the RAN 102 and communicates with the base station 50 through a wireless channel. The terminal 40 may be a user equipment, UE, a mobile station, a subscriber station, a remote terminal, a wireless terminal or the like.

A core network, CN 104, which is the network that manages or controls the RAN 102 and processes data and control signals for the terminal 40, transmitted and received via the RAN 102. The CN 104 performs various functions including control of a user plane and a control plane, processing of mobility, management of subscriber information, charging, and interworking with other types of systems such as the long-term evolution, LTE, system.

To perform the various functions described above, the CN 104 may include a plurality of functionally separated entities having different network functions, NFs. For example, the CN 104 may include an access and mobility management function AMF 90, a session management function, SMF 80, a user-plane function, UPF 30, a policy and charging function, PCF 85, a network repository function, NRF 95, a unified data management UDM 75, a network exposure function NEF 65, and a unified data repository UDR 55. Although, not shown in FIG. 2, the CN 104 may interwork with an application function, AF, a central network controller CNC, and a time-sensitive networking TSN system. The CN 104 may be referred as a 5th generation, 5G, core, 5GC, which is a core network of a 5G system.

The terminal 40 is connected to the RAN 102 and accesses the AMF 90, which performs a mobility management function of the CN 104. The AMF 90 is a function or a device that is responsible for both access to the RAN 102 and the mobility management of the terminal 40. The SMF 80 is a NF that manages a session. The AMF 90 is connected to the SMF 80, and the AMF 90 routes session-related messages of the terminal 40 to the SMF 80. The SMF 80 is connected to the UPF 30 to allocate a user plane resource to be provided to the terminal 40 and establishes a tunnel for transmitting data between the base station 50 and the UPF 30. The SMF 80, as a main entity managing a PDU session, may be responsible for QoS setting/update for QoS flows in the PDU session. The PCF 85 controls information associated with a policy and charging of a session used by the terminal 40. The NRF 95 stores information on NFs installed in the wireless communication operator network and performs a function of informing the stored information. The NRF 95 may be connected to all NFs. Each NF is registered with the NRF 95 when starting to run in the operator network, so as to inform the NRF 95 that the NF is running in the network. The UDM 75, as an NF that performs a role similar to a home subscriber server, HSS, of a 4G network, stores subscription information of the terminal 40 or context information used by the terminal 40 in the network.

The NEF 65 serves to connect a third party server to a NF in the 5G wireless communication system. In addition, the NEF 65 serves to provide data to the UDR 55 and to update or obtain data. The UDR 55 serves to store subscription information of the terminal 40, store policy information, store data exposed to the outside, or store information necessary for a 3-party application. Further, the UDR 55 also serves to provide stored data to other NFs.

The UDM 75, PCF 85, SMF 80, AMF 90, NRF 95, NEF 65, and UDR 55 may be connected to a service-based interface. Services or application programing interfaces, APIs, provided by NFs are used by other NFs and thus may exchange control messages with each other. For example, when the AMF 90 delivers a session-related message to the SMF 80, a service or API called Nsmf_PDUSession_CreateSMContext may be used. The AF may be configured in various manners. Although the AF is not explicitly shown in FIG. 2, the AF may be associated with the 5GC 104. The AF may be a 3rd-party entity outside the operator network or an entity inside the operator network. For example, a TSN AF may be an entity within 5GC, which is an operator network, since 5GC corresponds to an essential function for supporting TSN.

The TSN AF derives information about a TSN stream from information provided by central network controller, CNC, in the form of bridge management information, and possibly using other configuration data. The TSN AF determines the QoS parameters including: priority, the Maximum Burst Size, the delay and the Maximum Bitrate, and provides these parameters to the PCF. Additionally, the TSN AF constructs the TSC assistance container, which includes a burst arrival time, BAT, a period and a flow direction i.e., uplink or downlink direction.

The PCF 85 derives 5QI and the associated QoS parameters, and transmits them to the SMF 80 accordingly. The TSC assistance container is transferred transparently by the PCF 85 to the SMF 80.

The SMF 80 derives the TSCAI from the TSC Assistance Container. During the derivation of the TSCAI, the timing information is converted from a TSN external clock to a 5G clock. If the information is aggregated for multiple QoS flows, then the SMF 80 maps it to the individual flows. The SMF 80 also updates the BAT by adding the Packet Delay Budget, PDB, in the downlink, and the UE-DS-TT residence time in the uplink, to obtain a time interval on when the traffic arrives to RAN 102/UE 40.

The SMF 80 provides the TSCAI to the RAN 102 via the AMF 90. The SMF 80 also provides the flow QoS parameters to RAN 102 via the AMF 90. The RAN 102 takes into account the TSCAI in the resource allocation decisions. However, there is no feedback from the RAN 102 based on the TSCAI.

The RAN 102 may or may not be able to serve the TSC stream, but the RAN 102 has no way to respond to the TSCAI information and indicate whether or not it can satisfy the TSCAI.

Also, RAN has no way to indicate whether it could serve the stream with different parameters.

Therefore, according to some embodiments of the present disclosure, the network node i.e., a base station 50 of the RAN 102 implements a method for transmitting a response message to the AF or one or more network functions such as a network exposure function, NEF, to indicate whether or not the network node 50 satisfies the TSC configuration parameters in the TSCAI. Alternatively, the network node 50 may transmit an indication to the one or more network functions, i.e., for example, to the NEF or the AF for adjusting configuration of one or more TSC configuration parameters.

According to some embodiments of the present disclosure, the network node 50 receives the TSCAI, including TSC configuration parameters from the SMF 80, possibly via the AMF 90. When the network node 50 receives the TSCAI, the network node 50 transmits the response message intended for at least one network function associated with the CN 104, and the AF. The response message indicates whether or not the network node 50 satisfies the TSC configuration parameters in the TSCAI. Thus, the network node 50 transmits the response message to one or more network functions of the CN 104 and the AF, indicating whether the network node satisfies the TSC configuration parameters in the TSCAI.

The response message comprises one or more of: an indication whether at least one of the TSC flows is allowed to be established through the network node, a new BAT for a TSC flow, a delay interval for each BAT corresponding to each TSC flow, rank associated with respective TSC flow, quality of service, QoS, flow identifier, QFI, associated with the TSCAI, a periodicity, a delay interval, a survival time or the like.

Therefore, the network node 50 transmits the response message indicating whether or not the network node 50 satisfies the TSC configuration parameters in the TSCAI. If the network node 50 determines that one or more TSC configuration parameters in the TSCAI cannot be satisfied, then the network node 50 transmits an indication to the one or more network functions associated with the CN 104 and the AF for adjusting configuration of one or more TSC configuration parameters.

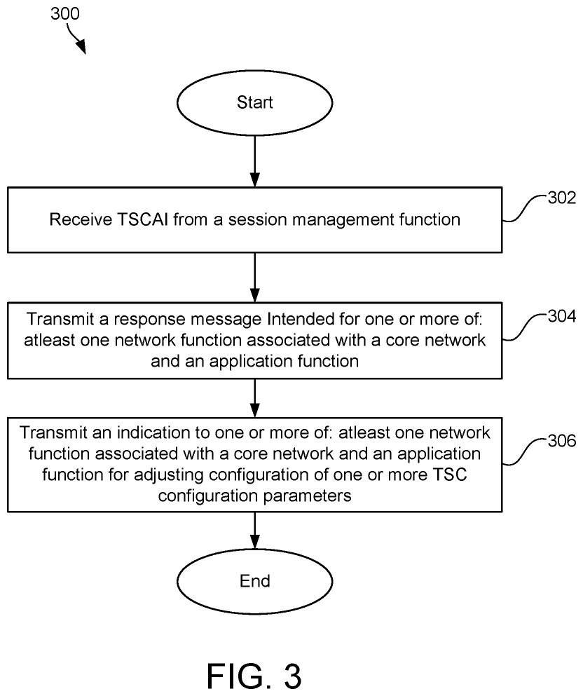

FIG. 3 is a flowchart illustrating example method steps of a method 300 for transmission of a response message for time sensitive communication performed by the network node of the access network in the wireless communication system. As stated above, the network node, i.e., the base station performs the method 300 for transmission of the response message to the network function(s) and the AF in the wireless communication system. The response message comprises one or more of: an indication whether at least one of the TSC flows is allowed to be established through the network node, a new BAT for a TSC flow, a delay interval for each BAT corresponding to each TSC flow, rank associated with respective TSC flow, quality of service, QoS, flow identifier, QFI, associated with the TSCAI, a periodicity, a survival time or the like. The network node transmits the response message intended the one or more network functions associated with the CN, and the AF.

At step 302, the method 300 comprises receiving the TSCAI including TSC configuration parameters from the SMF. For example, the network node receives the TSCAI from the SMF through the AMF.

In an embodiment, the TSC configuration parameters comprises one or more of: a direction of a TSC flow, a periodicity, a burst arrival time, BAT, a survival time, a rank indicating a priority for each of the TSC flow and a delay interval for each TSC flow.

The SMF determines the TSCAI from a TSC Assistance Container which includes a BAT, a flow direction, a survival time or the like. During the determination of the TSCAI, reference timing information is converted from a TSN external clock to the 5G clock. Further, the SMF transmits the determined TSCAI to the network node.

At step 306, the method 300 comprises transmitting a response message intended for one or more of: at least one network function associated with the CN, and the AF. The response message indicates whether or not the network node satisfies the TSC configuration parameters in the TSCAI. For example, the network node transmits a response message indicating that the network node satisfies the TSC configuration parameters in the TSCAI. In another example, the network node transmits a response message indicating that the network node cannot satisfy the TSC configuration parameters in the TSCAI. Thus, the network node transmits the response message indicating whether or not the network node is capable of satisfying the TSC configuration parameters in the TSCAI.

In an example, the network node transmits a response message intended for one or more network functions associated with the CN, and the AF through the SMF. Initially, the network node transmits the response message to the AMF and then the AMF transmits the response message to the SMF. Further, the SMF transmits the response message to the AF through the PCF. It may be possible that the network node may transmit the response message directly to the SMF and the SMF may transmit the response message directly to the AF.

In an example, the response message may be a new message from the network node or an existing message with some new parameters may be transmitted as the response message.

The response message may comprise one or more of: an indication whether at least one of the TSC flows is allowed to be established through the network node, a new BAT for a TSC flow, a delay interval for each BAT corresponding to each TSC flow, a rank associated with respective TSC flow, quality of service, QoS, flow identifier, QFI, associated with the TSCAI, a periodicity, a delay interval, a survival time or the like.

In an embodiment, the network node transmits the response message intended for one or more of: at least one network function associated with the CN, and the AF upon reception of the TSCAI.

Alternatively, the network node transmits the response message intended for one or more of: at least one network function associated with the CN, and the AF, when the network node determines that resources are available for allowing the TSC flows to be established through the network node.

At step 308, the method 300 comprises transmitting an indication to one or more of: the at least one network function associated with the CN, and the AF for adjusting configuration of one or more TSC configuration parameters. For example, the network node transmits an indication to the NEF or the AF through the one or more network functions for adjusting any of the TSC configuration parameters including a direction of a TSC flow, a periodicity, a burst arrival time, BAT, a survival time, a rank indicating a priority for each of the TSC flow and a delay interval for each TSC flow or the like.

The network node may transmit the indication for adjusting the TSC configuration parameters such that the network node satisfies the TSC configuration parameters.

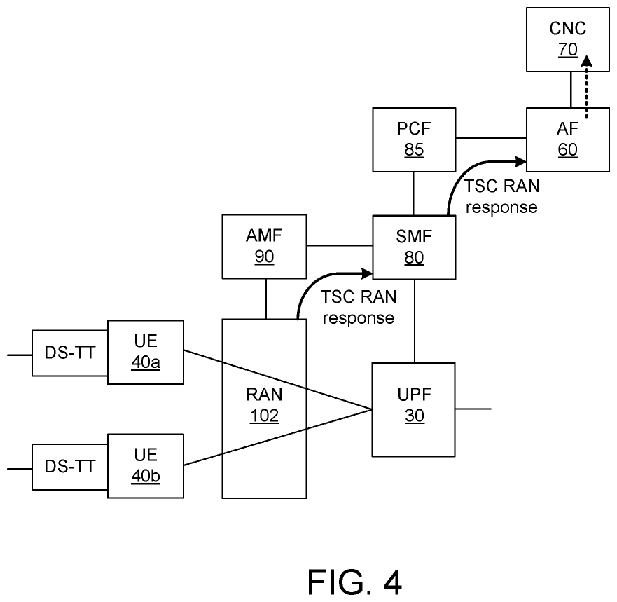

FIG. 4 is an example signaling diagram for transmission of a response message to the AF 60 through one or more network functions.

In an example, the RAN 102 can maintain information in a table about its own resources, and transmits the response message on the information. For example, the RAN 102 can maintain a table about the RAN resources available at a given arrival time based on a periodicity. Thus, the RAN 102 can determine whether or not it can serve a TSC stream that arrives with a given BAT, i.e., given phase within a period. The RAN 102 may also determine whether it could delay a TSC stream so that the TSC stream can be served.

In some instances, the RAN 102 may not satisfy two TSC streams that arrive at a same time interval with a given period, but the RAN 102 may satisfy both the TSC streams flows if they arrived with different BAT.

As depicted in the FIG. 4, the RAN 102 transmits the response message which is a TSC RAN response to the SMF 80. The response message may be a new message from the RAN 102 or an existing message with some new parameters may be transmitted by the RAN 102 as the response message.

Alternatively, although not shown in FIG. 4, the RAN transmits the response message i.e., the TSC RAN response to the AMF 90 and the AMF 90 transmits the TSC RAN response to the SMF 80. Further, the transmits the TSC RAN response to the PCF 85 and the PCF 85 in turn transmits the TSC RAN response to the AF 60.

The AF 60 may process the TSC RAN response appropriately. For example, in case of failure of the establishment of the TSN stream, the TSN AF may send the appropriate error indication to the CNC 70. It may also be possible that the AF 60 provides information to the CNC 70 based on the TSC RAN response as shown in FIG. 4.

In a similar manner, the proposed method can also be applicable for non-TSN scenario. In such case, the RAN 102 transmits the response message i.e., the TSC RAN response to the SMF 80 through the AMF 90. It should be noted that the response message may be a new message from the RAN 102 or an existing message with some new parameters may be transmitted by the RAN 102 as the response message. Further, the SMF 80 may perform some conversion, if applicable i.e., conversion of timing information from the 5G clock to the external TSN clock and transmits the response message via the PCF 85 and the NEF 65 to the AF 60.

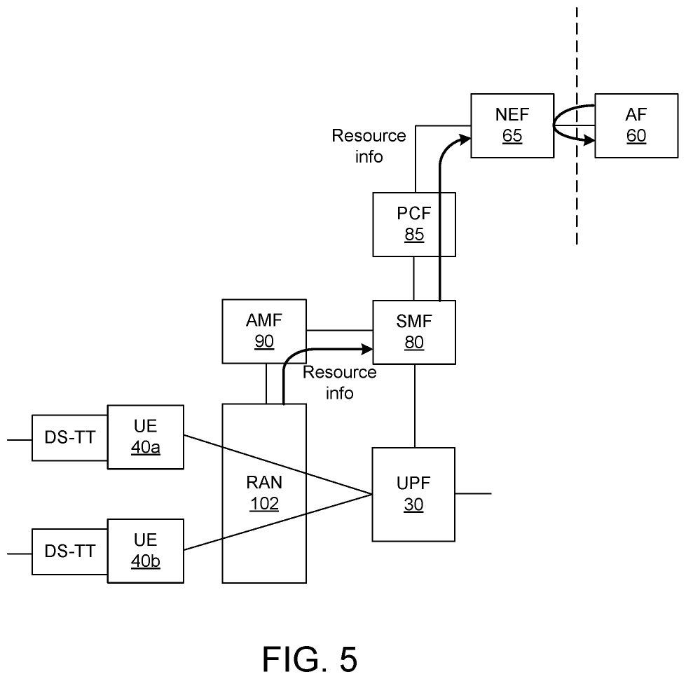

FIG. 5 is an example signaling diagram for transmission of resource availability information to a network exposure function through one or more network functions.

According to some embodiments of the present disclosure, the RAN 102 or the network node may indicate information about availability of resources at the network node for allowing the TSC flows to be established through the network node. In such case, the RAN 102 transmits the response message indicating availability of resources to the one or more network functions such as the NEF 65 or the AF 60.

The RAN 102 transmits the response message which includes information about availability of RAN resources to an intermediate node, such as the NEF 65, which can assist the NEF 65 in deciding whether to accepting or deny subsequent TSC flows. Alternatively, the PCF 85 may also act as an intermediate node instead of the NEF 65, for receiving the response message which includes the information about availability of RAN resources. In such cases, the PCF may authorize requests received from the AF 60.

As depicted in the FIG. 5, the RAN 102 may transmit the response message indicating the resource information to the SMF 80 through the AMF 90. Further, the SMF transmits the resource information to the NEF 65 through the PCF 85. The resource information may include, for example, whether new TSC flows with a certain delay requirement can be accepted or not. The information may also be given separately for a given Rank. Other alternatives also exist, with more detailed RAN resource information. Based on this information, the NEF 65 can make authorization decisions for future AF requests, so that the NEF 65 only accepts TSC flows when RAN resources are available.

The information in the NEF may be collected on a per RAN node basis, where the NEF may also collect information about which UE is connected to which RAN node. The resource information transmitted to the NEF may be used to immediately reject TSC flows when there are no resources available, without having to indicate to the RAN 102.

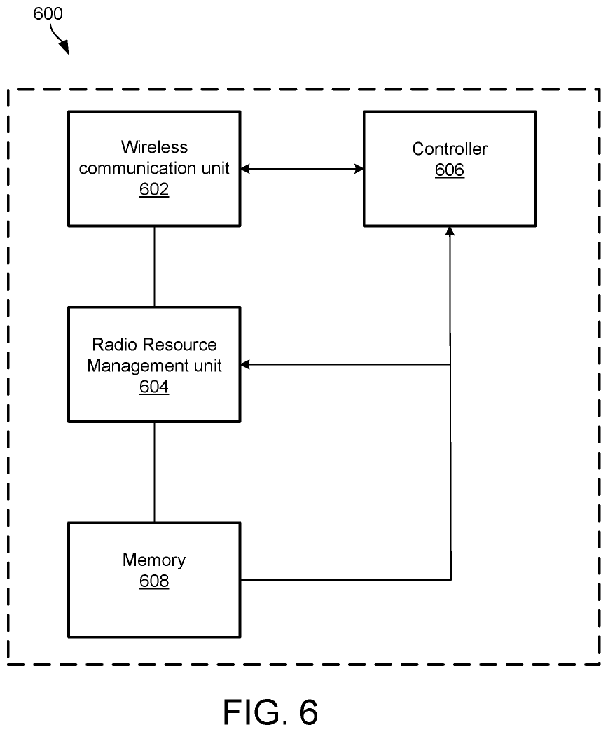

FIG. 6 is an example schematic diagram showing functional modules of the network node 50 for transmission of the response message. The network node 50 in the form of a base station of a wireless communication system is capable of transmitting the response message indicating whether or not the network node satisfies the TSC configuration parameters in the TSCAI. The network node 104 may comprise means arranged to perform the method 300 for transmission of the response message.

According to at least some embodiments of the present disclosure, the network node i.e., the base station 50 as illustrated in FIG. 6 may comprise a wireless communication unit 602, a radio resource management unit 604, and a memory 608. In addition, the base station 50 may also comprise a control unit 606, adapted to control said units.

The wireless communication unit 602 may be adapted to receive the TSCAI including the TSC configuration parameters from the SMF, corresponding to the step 302 of FIG. 3.

The wireless communication unit 602 may be adapted to transmit the response message intended for at least one network function associated with the CN and the AF, in communication with the radio resource management unit 604 corresponding to the step 304 of FIG. 3.

The radio resource management unit 604 may be adapted to determine availability of resources at the network node 50 for allowing the TSC flows to be established through the network node 50. When the radio resource management unit 604 determines the availability of the resources at the network node, the radio resource management unit 604 may be adapted to indicate the availability of resources to the wireless communication unit 602 and the wireless communication unit 602 may be adapted to transmit the response message indicating the availability of resources at the network node to the SMF.

The wireless communication unit 602, and the radio resource management unit 604 may be operatively connected to each other enabling the function of each of the units.

The memory 608 stores data, such as a basic program, applications, and TSC configuration parameters or the like. The memory 608 may be configured as volatile memory, non-volatile memory, or a combination of volatile memory and non-volatile memory.

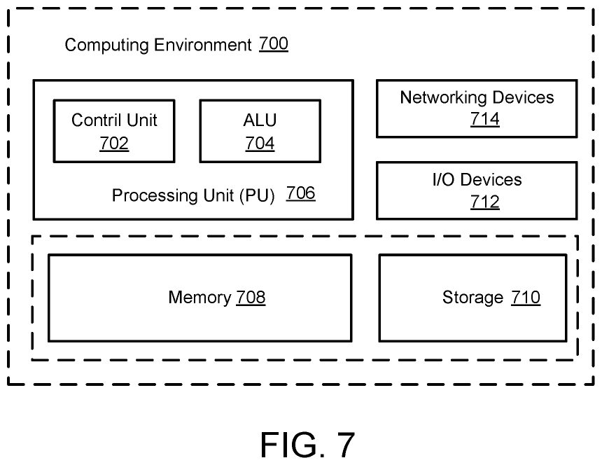

FIG. 7 illustrates an example computing environment 800 implementing a method and the network node for transmission of the response message as described in FIG. 3. As depicted in FIG. 7, the computing environment 700 comprises at least one data processing unit 706 that is equipped with a control unit 702 and an Arithmetic Logic Unit, ALU 704, a memory 712, a storage 714, plurality of networking devices 708 and a plurality Input output, I/O devices 710. The data processing unit 706 is responsible for processing the instructions of the algorithm. For example, the data processing unit 706 is equivalent to the processor of the network node. The data processing unit 706 is capable of executing software instructions stored in memory 712. The data processing unit 706 receives commands from the control unit 702 in order to perform its processing. Further, any logical and arithmetic operations involved in the execution of the instructions are computed with the help of the ALU 704.

The computer program is loadable into the data processing unit 706, which may, for example, be comprised in an electronic apparatus (such as a UE or a network node). When loaded into the data processing unit 706, the computer program may be stored in the memory 712 associated with or comprised in the data processor. According to some embodiments, the computer program may, when loaded into and run by the data processing unit 706, cause execution of method steps according to, for example, any of the methods illustrated in FIG. 3 or otherwise described herein.

The overall computing environment 700 may be composed of multiple homogeneous and/or heterogeneous cores, multiple CPUs of different kinds, special media and other accelerators. The data processing unit 706 is responsible for processing the instructions of the algorithm. Further, the plurality of data processing units 706 may be located on a single chip or over multiple chips.

The algorithm comprising of instructions and codes required for the implementation are stored in either the memory 712 or the storage 714 or both. At the time of execution, the instructions may be fetched from the corresponding memory 712 and/or storage 714, and executed by the data processing unit 706.

In case of any hardware implementations various networking devices 708 or external I/O devices 710 may be connected to the computing environment to support the implementation through the networking devices 708 and the I/O devices 710.

The embodiments disclosed herein can be implemented through at least one software program running on at least one hardware device and performing network management functions to control the elements. The elements shown in FIG. 7 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1-17. (canceled)

18. A method of transmission of a response message for a time sensitive communication (TSC), the method performed by a network node of an access network in a wireless communication system, the method (300) comprising:
receiving time-sensitive communication assistance information (TSCAI) including TSC configuration parameters from a session management function (SMF); and
transmitting a response message intended for at least one network function associated with a core network (CN) and/or an application function (AF);
wherein the response message indicates whether or not the network node satisfies the TSC configuration parameters in the TSCAI.

19. The method of claim 18, further comprising transmitting, to the at least one network function and/or to the AF, an indication to adjust configuration of one or more TSC configuration parameters.

20. The method of claim 18, wherein the TSC configuration parameters comprise one or more of:
a direction of a TSC flow;
a periodicity;
a burst arrival time (BAT);
a survival time;
a rank indicating a priority for each of the TSC flow and a delay interval for each TSC flow.

21. The method of claim 18, wherein the response message comprises one or more of:
an indication of whether at least one of the TSC flows is allowed to be established through the network node;
a new BAT for a TSC flow;
a delay interval for each BAT corresponding to each TSC flow;
the rank associated with the respective TSC flow;
a quality of service (QOS) flow identifier (QFI) associated with the TSCAI;
a periodicity;
a delay interval;
a survival time.

22. The method of claim 18, wherein transmitting the response message comprises transmitting the response message in response to the reception of the TSCAI.

23. The method of claim 18, wherein transmitting the response message comprises:
determining availability of resources at the network node for allowing the TSC flows to be established through the network node; and
transmitting the response message when the resources are available at the network node.

24. The method of claim 18, wherein transmitting the response message comprises transmitting the response message via one or more network functions of the CN.

25. The method of claim 24, wherein:
the response message indicates availability of resources at the network node; and
transmitting the response message via the one or more network functions of the CN comprises transmitting the response message to a network exposure function (NEF) of the CN.

26. A network node of a wireless communication system, the network node comprising:
processing circuitry and memory, the memory storing instructions executable by the processing circuitry whereby the network node is configured to:
receive time-sensitive communication assistance information (TSCAI) including TSC configuration parameters from a session management function (SMF); and
transmit a response message intended for at least one network function associated with a core network (CN) and/or an application function (AF);
wherein the response message indicates whether or not the network node satisfies the TSC configuration parameters in the TSCAI.

27. The network node of claim 26, further configured to transmit an indication, to the at least one network function and/or to the AF, to adjust configuration of one or more TSC configuration parameters.

28. The network node of claim 26, wherein the TSC configuration parameters comprise one or more of:
a direction of a TSC flow;
a periodicity;
a burst arrival time (BAT);
a survival time;
a rank indicating a priority for each of the TSC flow; and
a delay interval for each TSC flow.

29. The network node of claim 26, wherein the response message comprises one or more of:
an indication of whether at least one of the TSC flows is allowed to be established through the network node;
a new BAT for a TSC flow;
a delay interval for each BAT corresponding to each TSC flow;
the rank associated with the respective TSC flow;
a quality of service (QOS) flow identifier (QFI) associated with the TSCAI,
a periodicity;
a delay interval;
a survival time.

30. The network node of claim 26, wherein the network node is configured to transmit the response message in response to the reception of the TSCAI.

31. The network node of claim 26, wherein to transmit the response message, the network node is configured to:
determine availability of resources at the network node for allowing the TSC flows to be established through the network node; and
transmit the response message when the resources are available at the network node.

32. The network node of claim 26, wherein to transmit the response message, the network node is configured to transmit through one or more network functions of the CN.

33. The network node of claim 32, wherein:
the response message indicates availability of resources at the network node; and
to transmit the response message through one or more network functions of the CN, the network node is configured to transmit to a network exposure function (NEF) of the CN.

34. A non-transitory computer readable medium storing a computer program product for controlling a network node, the computer program product comprising software instructions that, when run on the network node, cause the network node to:
receive time-sensitive communication assistance information (TSCAI) including TSC configuration parameters from a session management function (SMF); and
transmit a response message intended for at least one network function associated with a core network (CN) and/or an application function (AF);
wherein the response message indicates whether or not the network node satisfies the TSC configuration parameters in the TSCAI.
